(19) United States
(12) Patent Application Publication
(10) Pub. No.: US 2018/0173627 A1
(43) Pub. Date: Jun. 21, 2018

(54) DYNAMIC MEMORY CONTROL METHOD AND SYSTEM THEREOF

(71) Applicant: MediaTek Inc., Hsin-Chu (TW)

(72) Inventors: Hong-Rong HSU, Hsinchu City (TW); Yuan-Tsung LO, Taichung City (TW); Hsin-Meng WANG, New Taipei City (TW); Cheng-Yuh WU, Hsinchu City (TW)

(21) Appl. No.: 15/128,274

(22) PCT Filed: Aug. 10, 2015
(86) PCT No.: PCT/CN2015/086470

§ 371 Date: Sep. 22, 2016

Related U.S. Application Data
(60) Provisional application No. 62/035,627, filed on Aug. 11, 2014.

(51) Int. Cl. G06F 12/0842; G06F 12/0804; G06F 13/40; G06F 15/82

(52) U.S. Cl. CPC G06F 12/0842; G06F 12/0804; G06F 2212/608; G06F 15/82; G06F 2212/1041; G06F 13/4081

(57) ABSTRACT

A dynamic memory control method for clusters includes at least one processor core and for cache memories each belonging to a corresponding cluster of the clusters. The dynamic memory control method includes borrowing a first portion of cache memory from a first cache memory and/or a second portion of cache memory from a second cache memory to allow the first portion and/or the second portion of cache memory to be utilized as a temporary internal RAM, and returning the first portion of cache memory to the first cache memory and/or the second portion of cache memory to the second cache memory such that each of the first portion and/or the second portion of cache memory is exclusively used by the at least one processor core of the first cluster and/or the second cluster.

### CROSS REFERENCE TO RELATED APPLICATIONS

This application claims the benefit of U.S. Provisional Application No. 62/035,627, filed on Aug. 11, 2014, the entirety of which is incorporated by reference herein.

### TECHNICAL FIELD

The disclosure generally relates to a dynamic memory control method and its system, and more particularly, to a dynamic memory control method for borrowing and returning cache memories in a run time.

### BACKGROUND

Generally, within a system, a memory is utilized by many different hardware or modules. For example, the hardware or modules are arranged on a chip, and the memory is arranged on another chip. As such, the memory is accessed by the hardware or modules through an external memory interface (EMI). However, if there are too many hardware or modules utilizing the memory at the same time, the bandwidth of the EMI will be occupied which results in high latency of the system. In addition, the performance of the system can also become deteriorated.

An internal memory is provided to solve the above problem. The internal memory is arranged on the same chip with the hardware and modules, and it functions as a shared buffer so that it can be accessed by much hardware without passing through the EMI. In other words, the data transmission between the hardware and the memory is kept in the same chip to save the bandwidth of the EMI, decrease the latency and improve the performance of the system. However, the cost of the internal memory is high, and the size of the internal memory is also limited due to its system-on-chip (SOC) design. Moreover, the arrangement of the internal memory could be wasted or inefficient if only one or a few hardware devices require the internal memory in some periods.

Therefore, a dynamic memory control method for borrowing and returning cache memories in a run time is needed.

### SUMMARY

A dynamic memory control method is proposed for a system including a plurality of clusters each comprising at least one processor core respectively and for a plurality of cache memories each belonging to a corresponding cluster of the clusters. The dynamic memory control method includes borrowing a first portion of cache memory from a first cache memory of the plurality of cache memories and/or a second portion of cache memory from a second cache memory of the plurality of cache memories to allow the first portion of cache memory and/or the second portion of cache memory to be utilized as a temporary internal RAM (random access memory), and returning the first portion of cache memory to the first cache memory and/or the second portion of cache memory to the second cache memory such that each of the first portion of cache memory and/or the second portion of cache memory is exclusively used by the at least one processor core of the first cluster and/or the at least one processor core of the second cluster. The first cache memory belongs to a first cluster of the plurality of clusters, and the second cache memory belongs to a second cluster of the plurality of clusters.

In one aspect of the invention, when the first portion of cache memory and/or the second portion of cache memory are utilized as the temporary internal RAM, the temporary internal RAM is shared by the at least one processor core of the first cluster and/or the at least one processor core of the second cluster with either or both of the at least one processor core of the plurality of clusters and one or more other modules other than the at least one processor core of the first cluster and/or the at least one processor core of the second cluster. In step of utilizing the first portion of cache memory and/or the second portion of cache memory as the temporary internal RAM, a boot loader is executed in the temporary internal RAM to initiate an external RAM. In addition, the dynamic memory control method includes translating a memory access request for the temporary internal RAM into a first memory access request for the first portion of cache memory and/or a second memory access request for the second portion of cache memory. When the first portion of cache memory and the second portion of cache memory are both borrowed, they are utilized as a single contiguous temporary internal RAM.

In another aspect of the invention, the returning step is performed without powering off the first cluster and the second cluster, and the borrowing step and the returning step are performed by a first processor core of the first cluster. Furthermore, the hot plug mechanism is disabled for processor cores other than the first processor core. After step of disabling hot plug mechanism for processor cores other than the first processor core, the dynamic memory control method includes flushing respective cache memories belonging to the clusters other than the first cluster, and disabling a respective instruction cache memory and a respective data cache memory of the cache memories belonging to the clusters other than the first cluster, flushing the first cache memory belonging to the first cluster, disabling an instruction cache memory and a data cache memory of the first cache memory belonging to the first cluster, switching architecture of the at least one processor core into a single-core architecture, and enabling the second cluster to power on the second cache memory. After either the borrowing step or the returning step, the dynamic memory control method includes enabling the first cache memory belonging to the first cluster, switching an architecture of the at least one processor core into a multi-core architecture, and enabling the hot plug mechanisms for the processor cores other than the first processor core.

In another aspect of the invention, the dynamic memory control method includes identifying a current scenario and determining whether the current scenario matches any scenario recorded in a scenario table or not. The scenario table records a plurality of scenarios each corresponding to different combinations of sizes of cache memories to be borrowed. When the current scenario matches a scenario recorded in the scenario table, the borrowing of cache memories is determined according to the combination of sizes of cache memories to be borrowed corresponding to the current scenario. The dynamic memory control method also includes obtaining a required size of the temporary internal RAM; and obtaining a first required size of the first portion of cache memory to be borrowed from the first cache memory and/or a second required size of the second portion of cache memory to be borrowed from second cache memory according to the required size of the temporary internal RAM.

In yet another aspect of the invention, a dynamic memory control system is provided for a plurality of clusters. Each of the clusters comprises at least one processor core respectively and for a plurality of cache memories each belonging to a corresponding cluster of the clusters. The dynamic memory control system includes a first cache memory of the plurality of cache memories, wherein the first cache memory belongs to a first cluster of the plurality of clusters, and a second cache memory of the plurality of cache memories which is different from the first cache memory. The second cache memory belongs to a second cluster of the plurality of clusters which is different from the first cluster, and a first portion of cache memory is borrowed from the first cache memory of the plurality of cache memories and/or a second portion of cache memory is borrowed from a second cache memory of the plurality of cache memories to allow the first portion of cache memory and/or the second portion of cache memory to be utilized as a temporary internal RAM, and the first portion of cache memory is returned to the first cache memory and/or the second portion of cache memory is returned to the second cache memory such that each of the first portion of cache memory and/or the second portion of cache memory is exclusively used by the at least one processor core of the first cluster and/or the at least one processor core of the second cluster.

In yet another aspect of the invention, a dynamic memory control method is provided for borrowing the cache memories. The dynamic memory control method includes identifying a current scenario; determining whether the current scenario matches any scenario recorded in a scenario table or not; determining to borrow cache memories according to the combination of sizes of cache memories to be borrowed corresponding to the current scenario if it is matched; binding the configuration to the first processor core; disabling hot plug mechanism for processor cores other than the first processor core; flushing respective cache memories belonging to the clusters other than the first cluster, and disabling a respective instruction cache memory and a respective data cache memory of the cache memories belonging to the clusters other than the first cluster; flushing the first cache memory belonging to the first cluster, and disabling an instruction cache memory and a data cache memory of the first cache memory belonging to the first cluster and switching architecture of the at least one processor core into a single-core architecture; enabling the second cluster to power on the second cache memory; borrowing a first portion of cache memory from a first cache memory and/or a second portion of cache memory from a second cache memory; and switching an architecture of the at least one processor core into a multi-core architecture; raising the cache-borrowing flag and enabling the hot plug mechanisms for the processor cores other than the first processor core.

In yet another aspect of the invention, a dynamic memory control method is provided for returning the cache memories. The dynamic memory control method includes identifying a current scenario; determining whether the current scenario matches any scenario recorded in a scenario table or not; determining to return cache memories according to the combination of sizes of cache memories to be returned corresponding to the current scenario if it is matched; binding the configuration to the first processor core; disabling hot plug mechanism for processor cores other than the first processor core; flushing respective cache memories belonging to the clusters other than the first cluster, and disabling a respective instruction cache memory and a respective data cache memory of the cache memories belonging to the clusters other than the first cluster; flushing the first cache memory belonging to the first cluster, and disabling an instruction cache memory and a data cache memory of the first cache memory belonging to the first cluster and switching architecture of the at least one processor core into a single-core architecture; enabling the second cluster to power on the second cache memory; returning a first portion of cache memory to a first cache memory and/or a second portion of cache memory to a second cache memory; enabling the first cache memory belonging to the first cluster, and switching architecture of the at least one processor core into a multi-core architecture; releasing the cache-borrowing flag, and disabling the power of the second cluster, and enabling the hot plug mechanisms for the processor cores other than the first processor core.

In the embodiments, flexible usage of the cache memories allows EMI bandwidth to be saved without needing to arrange a specific internal RAM device in advance, thus decreasing the manufacturing cost. In addition, latency of accessing the temporary RAM can also be reduced.

Other aspects and features of the present invention will become apparent to those with ordinarily skill in the art upon review of the following descriptions of specific embodiments of the dynamic memory control method and the dynamic memory control system.

### BRIEF DESCRIPTION OF DRAWINGS

The invention can be more fully understood by reading the subsequent detailed description and examples with references made to the accompanying drawings, wherein:

FIG. 1A is a schematic diagram of a dynamic memory control system according to an embodiment of the invention;

FIG. 1B is another schematic diagram of a dynamic memory control system according to an embodiment of the invention;

FIG. 2 is another schematic diagram of a dynamic memory control system according to an embodiment of the invention;

FIG. 3A-1&3A-2 is a flow chart illustrating the borrowing of cache memories for a dynamic memory control method according to an embodiment of the invention;

FIG. 3B-1&3B-2 is a flow chart illustrating the returning of cache memories for a dynamic memory control method according to an embodiment of the invention;

FIG. 3C-1&3C-2 is a flow chart illustrating the borrowing of cache memories for a dynamic memory control method according to another embodiment of the invention;

FIG. 3D-1&3D-2 is a flow chart illustrating the returning of cache memories for a dynamic memory control method according to another embodiment of the invention.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION

In order to illustrate the purposes, features and advantages of the invention, the embodiments and figures of the invention are shown in detail as follows. This description is made for the purpose of illustrating the general principles of the invention and should not be taken in a limiting sense. It should be understood that the embodiments may be realized in software, hardware, firmware, or any combination thereof.

In addition, it should be noted that the term “multi-core processor system” may mean a multi-core system or a multi-processor system, depending upon the actual design. In other words, the proposed switching method may be employed by any of the multi-core system and the multi-processor system. For example, concerning the multi-core system, all of the processor cores may be disposed in one processor core. For another example, concerning the multi-processor system, each of the processor cores may be disposed in one processor core. Hence, each of the clusters may be implemented as a group of processor cores.

In embodiments of the disclosure, flexible usage can be applied to the cache memories by dynamically borrowing/returning them in different occasions if required. Borrowed portion(s) of one or more cache memories can be utilized as a temporary internal RAM (random access memory), which may then be used by not only the processor core(s) in the same cluster of the borrowed one or more cache memories but also the processor core(s) in different cluster(s) and/or other module(s).

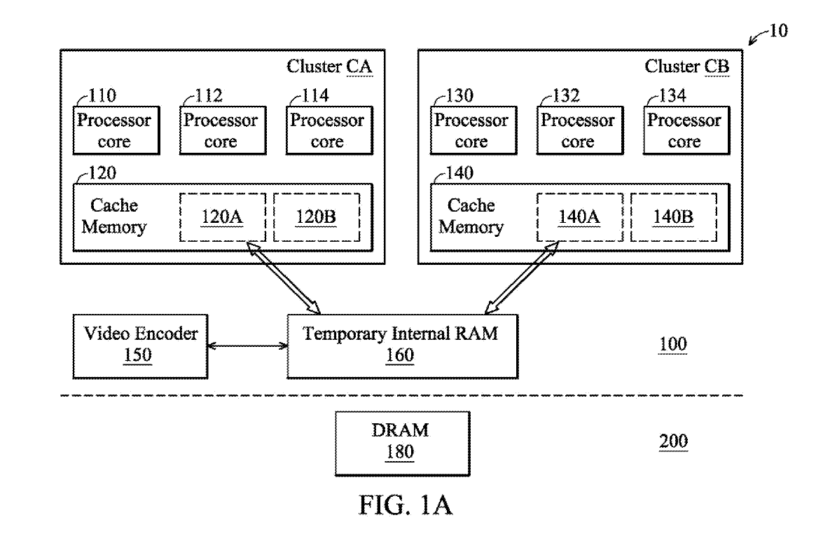

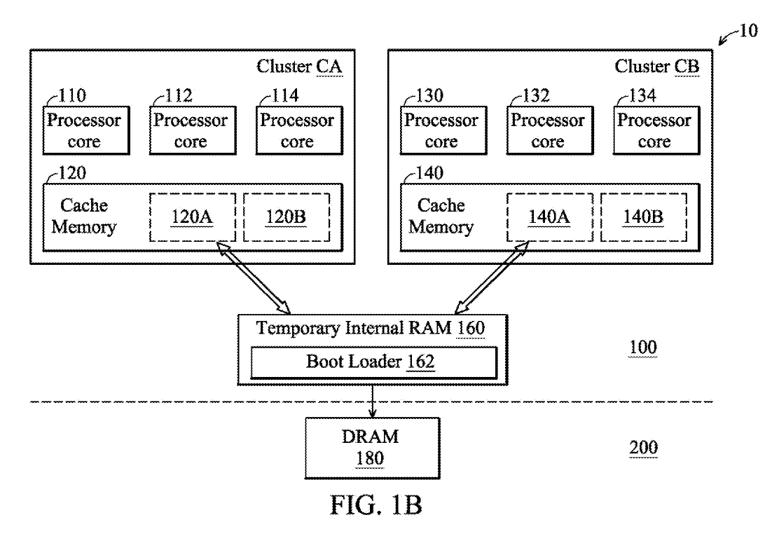

FIG. 1A is a schematic diagram of a dynamic memory control system according to an embodiment of the invention. The dynamic memory control system 10, for example, could be embedded or included within an electronic apparatus. The electronic apparatus could be a mobile electronic device such as a cell phone, a tablet computer, a laptop computer or a PDA, or could it be an electronic device such as a desktop computer or a server.

The dynamic memory control system 10 can be a multi-core processor system, including at least one cache memory, and each of the cache memories can belong to a cluster respectively. In addition, each of the clusters includes at least one processor core. As exemplarily shown in FIG. 1A, the dynamic memory control system 10 includes a plurality of cache memories, for example, cache memories 120 (the first cache memory) and 140 (the second cache memory), which belong to the clusters CA (the first cluster) and CB (the second cluster) respectively. The cluster CA includes one or more processor cores, for example processor cores 110, 112 and 114. Similarly, the cluster CA further includes one or more corresponding cache memories, for example, cache memory 120. In addition, the cache memory 120 can include one or more portions, illustrated as portions 120A (hereafter referred to “first portion”) and 120B, for example. Similarly, the cluster CB includes one or more processor cores, for example processor cores 130, 132 and 134. Similarly, the cluster CA further includes one or more corresponding cache memories, for example, cache memory 140, which includes one or more portions, illustrated as portions 140A (the second portion) and 140B for example.

Each of the processor cores 110˜114 and 130˜134 may be a digital signal processor core (DSP), a microcontroller (MCU), a central-processing unit (CPU) or a plurality of parallel processor cores relating the parallel processing environment to implement the operating system (OS), firmware, driver and/or other applications of the electronic device. On the other hand, the cache memories 120 and 140 may be, for example, level 2 (L2) cache memories. In some embodiments, each of the cache memories 120 and 140 includes at least one instruction cache memory and at least one data cache memory.

Flexible usage can be applied to the cache memories 120 and 140, by dynamically borrowing/returning them in different occasions if required. In some occasions, the cache memories 120 and 140 can be dedicated to the processor cores 110˜114 and 130˜134 in the same clusters CA and CB, respectively, meaning that the processor cores belonging to different clusters (CB for cache memories 120; and CA for cache memories 140) and other hardware/software modules such as the video encoder 150 are not allowed to access or utilize the cache memories 120 and 140. However, in some other occasions, at least one portion, e.g., the portion 120A of cache memory can be borrowed from the cache memory 120 of the plurality of cache memories and/or at least one portion, e.g., portion 140A of cache memory can be borrowed from the cache memory 140 of the plurality of cache memories. After being borrowed, the portion 120A of cache memory and/or the portion 140A of cache memory can be utilized as a temporary internal RAM 160 (random access memory), which may then be used by not only the processor core(s) in the same cluster but also the processor core(s) in different cluster(s) and/or other module(s).

The temporary internal RAM 160, which includes at least the portions 120A and/or 140A of cache memories, can be a general purpose SRAM. When portion 120A is borrowed as (a part or a whole of) the temporary internal RAM 160, it can be used by not only the processor cores 110, 112, 114 in the same cluster CA, but also one or more other processor cores not belonging to cluster CA, for example, by at least one processor core belonging to cluster CB and/or other one or more clusters, and/or one or more other software/hardware modules other than the clusters, e.g., the video encoder 150. Similarly, when portion 140A is borrowed as (a part or a whole of) the temporary internal RAM 160, it can be used by not only the processor cores 130, 132, 134 in the same cluster CB, but also one or more other processor cores not belonging to cluster CA, for example, by at least one processor core belonging to cluster CA and/or other one or more clusters, and/or one or more other software/hardware modules other than the clusters, e.g., the video encoder 150. Similarly, when portions 120A and 140A are both borrowed as (a part of w whole of) the temporary internal RAM 160, the temporary internal RAM 160 can be used by not only the processor cores 110, 112, 114 belonging to the cluster CA and the processor cores 130, 132, 134 belonging to the cluster CB, but also one or more other software/hardware modules other than the clusters CA and CB, e.g., the video encoder 150.

Afterwards, when there is no need for the temporary internal RAM 160, the portion 120A of cache memory can be returned to the cache memory 120 and/or the portion 140A of cache memory is returned to the cache memory 140, respectively. After being returned, each of the portion 120A of cache memory and/or the portion 140A of cache memory is back to be exclusively or dedicatedly used by the at least one processor core 110˜114 of the cluster CA and/or the at least one processor core 130˜134 of the cluster CB again.

It should be noted that the temporary internal RAM 160 could exist only when the portions 120A and 140A are borrowed from the cache memories 120 and 140. In other words, the internal RAM 160 may be utilized temporarily rather than permanently. As will be explained below, one improvement brought by the flexible usage of cache memory is that EMI bandwidth can be saved without needing to arrange a specific internal RAM device in advance, and the manufacturing cost can be decreased accordingly. In addition, latency of accessing the temporary RAM can be reduced.

In one example, if the required size of the temporary internal RAM 160 is 256 KB which indicates a large size, the portion 120A with the size of 128 KB may be borrowed from the cache memory 120 and/or the portion 140A with the size of 128 KB may be borrowed from the cache memory 140. In another example, if the required size of the temporary internal RAM 160 is 128 KB which indicates a small size, the portion 120A with the size of 128 B may be borrowed from the cache memory 120 without the borrowing from another cache memory 140.

It is noted that the locations and sizes of the portions to be borrowed/returned (e.g., portions 120A and 140A) of cache memories can be dynamically determined, for example, according to different scenarios or real-time requirements in some embodiments, but can be fixed in other embodiments. More details will be described more in the following.

Regarding the usage of the temporary internal RAM 160, please refer to FIG. 1A. When (a portion of) any cache memory becomes (a portion or a whole of) the temporary internal RAM 160, it can be used not only by its corresponding processor core(s) (i.e., the processor core(s) which is within the same cluster and originally having an exclusive access right to access it) but also by at least one other processor core located in different cluster(s) or one or more software/hardware modules other than the clusters. Specifically, the temporary internal RAM 160 can be shared by the at least one processor core of the cluster CA and/or the at least one processor core of the cluster CB with the at least one processor core of the plurality of clusters and one or more software/hardware modules other than the at least one processor core of the first cluster and/or the at least one processor core of the second cluster.

For example, the temporary internal RAM 160 can be shared by the processor core 110 of the cluster CA with the processor cores 112˜114 of the cluster CA and the processor cores 130˜134 of the cluster CB, and/or the video encoder 150. In another example, the temporary internal RAM 160 is shared by the processor core 110 of the cluster CA and the processor core 130 of the cluster CB with the processor cores 112˜114 of the cluster CA and the processor cores 132˜134 of the cluster CB, and/or the video encoder 150.

The description of the two clusters CA and CB is for illustration and not for limitation. For example, the temporary internal RAM 160 could be further shared with more than two clusters. The number of the clusters and the processor cores which the temporary internal RAM 160 is shared with is not limited in the disclosure. In another example, the temporary internal RAM 160 could be further shared with other software/hardware modules such as the video encoder 150 on the chip 100.

It should be noted that in some embodiments, when the portions 120A and 140A of cache memories are both borrowed to form the temporary internal RAM 160, they are utilized as a single contiguous temporary internal RAM. In such an implementation, complex memory management may not be needed for accessing the temporary internal RAM 160.

As shown in FIG. 1A, the clusters CA, CB, the video encoder 150 and the temporary internal RAM 160 can be arranged in the chip 100, and a DRAM 180 can be arranged in a chip 200 that is different from the chip 100. In other words, the DRAM 180 is an external RAM since it is located on another chip 200 rather than on the chip 100. Because DRAM 180 is outside chip 100, accessing DRAM 180 by the video encoder 150 on the chip 200 occupies bandwidth of EMI, especially when the DRAM 180 is accessed by other hardware/software modules at the same time. In addition, transmitting data by the video encoder 150 between different chips 100 and 200 causes high latency and low performance for the video encoder 150 which results in data loss or accuracy problems.

However, these problems can be solved in the embodiment shown in FIG. 1A, for the video encoder 150 could access the temporary internal RAM 160 on the same chip 100. Because the internal RAM 160 is arranged within the same chip with the clusters CA and CB, it could be accessed more quickly by the processor cores 110˜114 and 130˜134. Consequently, the bandwidth of the EMI can be saved, and both the latency and the performance of the video encoder 150 could be improved without causing extra cost for another permanent internal RAM.

FIG. 1B is another schematic diagram of a dynamic memory control system 10 according to an embodiment of the invention. In this embodiment, when the portions 120A and 140A of cache memories are both borrowed to form the temporary internal RAM 160, a boot loader 162 can be arranged or executed in the temporary internal RAM 160 to initiate the DRAM 180. After the DRAM 180 has been initiated, it can be accessed by other hardware/software modules. Because the boot loader 162 is arranged within the temporary internal RAM 160, another permanent internal RAM may not be required. Accordingly, cost can be reduced in the simple configuration of the dynamic memory control system 10.

In one embodiment, the borrowing and the returning of the portion 120A and/or the portion 140A of cache memories are performed by a specific processor core. Preferably but not limitedly, the specific processor core is a first processor core of the first cluster or a processor core for handling interrupting requirements. For example, the borrowing and the returning of cache memories are performed by the processor core 110 of the cluster CA.

Afterwards, a hot plug mechanism can be disabled (e.g., by the processor core 110 but not limited thereto) for processor cores 112˜114 and 130˜134 other than the processor core 110. The hot plug mechanism can be utilized to dynamically activate or de-activate the processor cores without powering off or resetting them. More specifically, when the hot plug mechanism is disabled for the processor cores 112˜114 and 130˜134, the above processor cores are temporarily disabled or de-activated so that the borrowing or the returning of cache memories may not be disturbed or influenced by the above processor cores 112˜114 and 130˜134.

After the hot plug mechanism is disabled for processor cores 112˜114 and 130˜134 other than the processor core 110, respective cache memories belonging to the clusters other than the cluster CA may be flushed, and a respective instruction cache memory and a respective data cache memory of the cache memories belonging to the clusters other than the cluster CA may be disabled. For example, the cache memory 140 belonging to the cluster CB is flushed, and the respective cache memory and the respective data cache memory of the cache memory 140 are disabled.

The primary reason for flushing the cache memory 140 is to update the data of the cache memory 140 and the DRAM 180 such that the data stored in the cache memory 140 and the DRAM 180 are coherent. After data is transmitted from the DRAM 180 to the cache memory 140, it can be accessed by the at least one of the processor cores 110˜114 of cluster CA, thus becoming different from the original data stored in the DRAM 180. Therefore, the flushing can be performed to synchronize the cache memory 140 and the DRAM 180, meaning to make data stored in the cache memory 140 and the DRAM 180 coherent.

Furthermore, after the respective cache memories are flushed and the respective instruction cache memory and the respective data cache memory are disabled, the cache memory 120 belonging to the cluster CA can be flushed, an instruction cache memory and a data cache memory of the cache memory 120 belonging to the cluster CA can be disabled, and an architecture of the at least one processor core can be switched into a single-core architecture since other processor cores 112˜114 and 130˜134 have been disabled with the hot plug mechanism.

Afterwards, the cluster CB can be enabled to power on the cache memory 140. Because the cluster CB and its processor cores 130˜134 are disabled with the hot plug mechanism, the cluster CB can be enabled such that the cache memory 140 is powered-on to be borrowed/returned by the processor core 110.

When the temporary internal RAM 160 is not required, the processor core 120 can return the portions 120A and 140A to the cache memories 120 and 140 respectively. In one embodiment, after either the borrowing and the returning of the portions 120A and 140A of cache memories, the cache memory 120 belonging to the cluster CA is enabled, and the architecture of the at least one processor core is switched into a multi-core architecture. Afterwards, the hot plug mechanism can be enabled for the processor cores 112˜114 and 130˜134 other than the processor core 120.

It is noted that the returning of the portions 120A and 140A of cache memories may be performed by the processor core 120 without powering off the cluster CA and the cluster CB. Because the clusters CA and CB are not be required to be powered off, the borrowing and returning of cache memories can be performed dynamically and instantly to enhance the performance and capability of the dynamic memory control system 10.

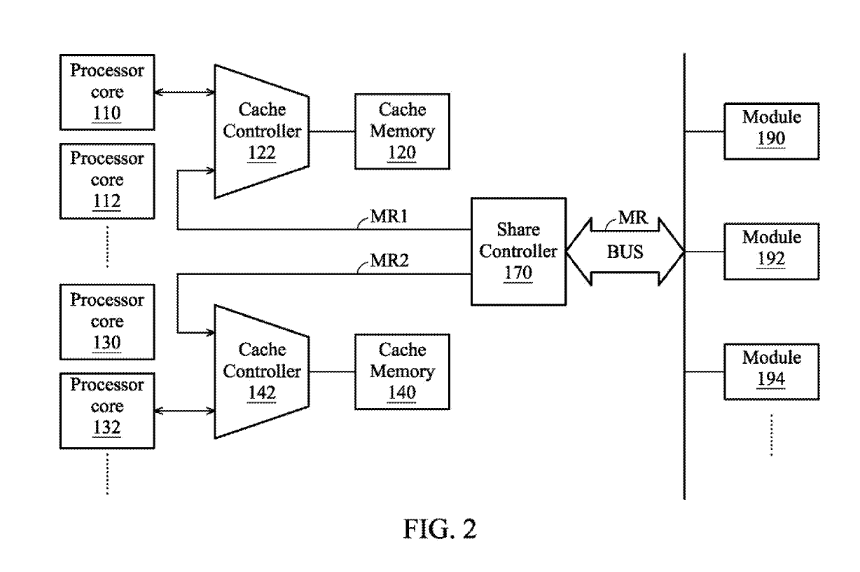

FIG. 2 is another schematic diagram of a dynamic memory control system 10 according to an embodiment of the invention. The dynamic memory control system 10 includes one or more cache memories 120 and 140, one or more cache controllers 122 and 142, a share controller 170, one or more modules 190, 192 and 194, and a plurality of processor cores 110, 112, 130 and 132.

The processor cores 110 and 112 belonging to a cluster can access the cache memory 120 through the cache controller 122. Similarly, the processor cores 130 and 132 belonging to another cluster can access the cache memory 140 through the cache controller 142. The share controller 170 can be coupled to the two cache controllers 122 and 142 and communicates with the hardware/software modules 190-194 through a bus as illustrated. The share controller 170 may be utilized to allocate the bandwidth of the EMI. On the other hand, either of the modules 190, 192, and 194 may be a direct memory access (DMA) unit, a graphical processing unit (GPU), and a display control unit.

In one embodiment, after the portions 120A and 140A are borrowed from the cache memories 120 and 140 to form temporary internal RAM 160, a memory access request MR for the temporary internal RAM 160 can be generated by either of the users, i.e., either of the processor cores 110-132 and/or the modules 190-194. To access the temporary internal RAM 160 which is actually formed by the portion 120A of the cache memory 120 and/or translated the portion 120B of the cache memory 140, the memory access request MR can be translated, by the share controller 170, into a first memory access request MR1 for the portion 120A of the cache memory 120 and/or translated into a second memory access request MR2 for the portion 120B of the cache memory 140.

More specifically, the share controller 170 can receive a memory access request MR (such as the read or write request) from at least one of the modules 190˜194, and translate the received memory access request MR to be suitable for accessing the cache memories 120 and 140, particularly for translation of protocols and conversion of access addresses. To this end, the share controller 170 can be implemented with a function of protocol translation, address decoding, and/or data multiplexing/merging logic. After being translated by the share controller 170, the memory access request MR can be converted into the first memory access request MR1 and/or the second memory access request MR2, each of which including information about the target cache memory 120 or 140, an access address for the target cache memory 120 or 140, and read or write data.

In some embodiments, whether to form a temporary internal RAM 160 and a required size thereof, and even the target cache memory to be borrowed can be calculated or determined by either or both of a driver layer and the sharing controller 170. In addition, the calculation or determination can be based on a current scenario. However, additionally or alternatively, the required size of the temporary internal RAM 160 could also be directly assigned or requested by users in real-time.

In one embodiment, a current scenario can be identified and analyzed to determine when to borrow and return of cache memories and required sizes. For example, a driver layer may identify the current scenario and then direct the share controller 170 to allocate the bandwidth or execute the borrowing/returning process for the cache memories based on the identified current scenario.

To this end, the dynamic memory control system 10 can be implemented to include or be able to access a scenario table, which may record a plurality of scenarios. In addition, whether or not the current scenario matches any scenario recorded in the scenario table may be determined by the share controller 170 and/or the driver layer.

In one embodiment, the scenario table includes several different levels of scenarios arranged according to respective occupying bandwidths and the loadings, and accompanied by different required internal RAM memory sizes to be utilized or different cache memories sizes to be borrowed. In one embodiment, each of the scenarios may correspond to different required sizes of the temporary internal RAM 160. In another embodiment, each of the scenarios may correspond to different combinations of sizes of cache memories 120 and 140 to be borrowed.

For example, when the current scenario matches a scenario recorded in the scenario table, respective sizes of cache memories to be borrowed can be determined according to the combination of sizes of cache memories recorded to correspond to the current scenario. If the scenario occupies much bandwidth and/or causes/indicates heavy loading to the processor cores, the current scenario can be determined to be a high level according to the scenario table for borrowing a larger size of cache memories. Accordingly, the larger size of cache memories would be borrowed from many cache memories of different clusters. Conversely, if the scenario occupies little bandwidth or indicates or causes light loading to the processor cores, the scenario will be determined to be a low level according to the scenario table for borrowing a smaller size of cache memories. Accordingly, the smaller size of cache memories would be borrowed from one or two cache memories of different clusters.

In another embodiment, when the current scenario matches a scenario recorded in the scenario table, a required size of the temporary internal RAM 160 is obtained. Afterwards, a first required size of the portion 120A of cache memory to be borrowed from the cache memory 120 and/or a second required size of the portion 140A of cache memory to be borrowed from the cache memory 140 can be obtained according to the required size of the temporary internal RAM 160, for example, by either or both of the share controller 170 and the driver layer.

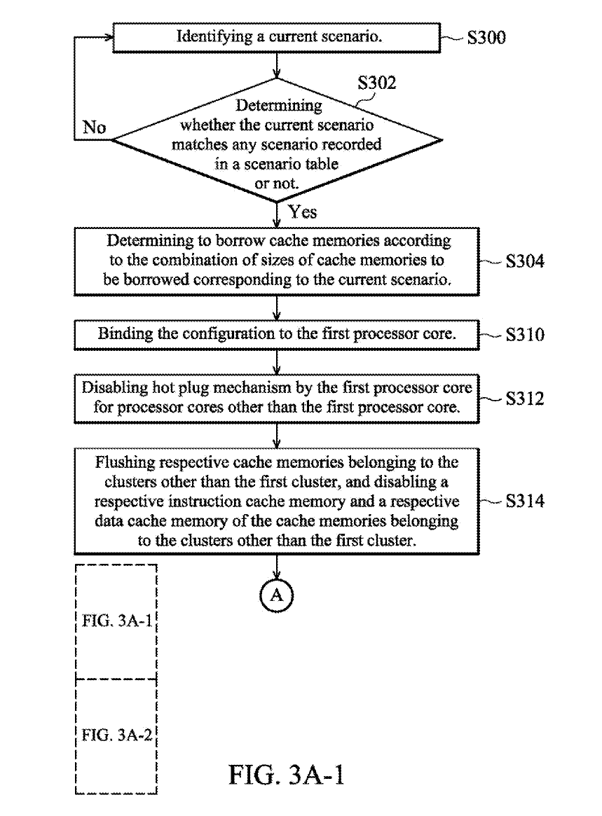

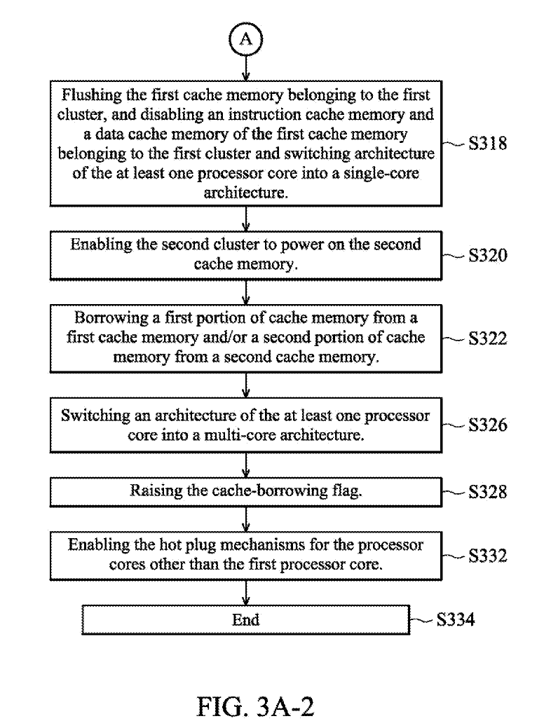

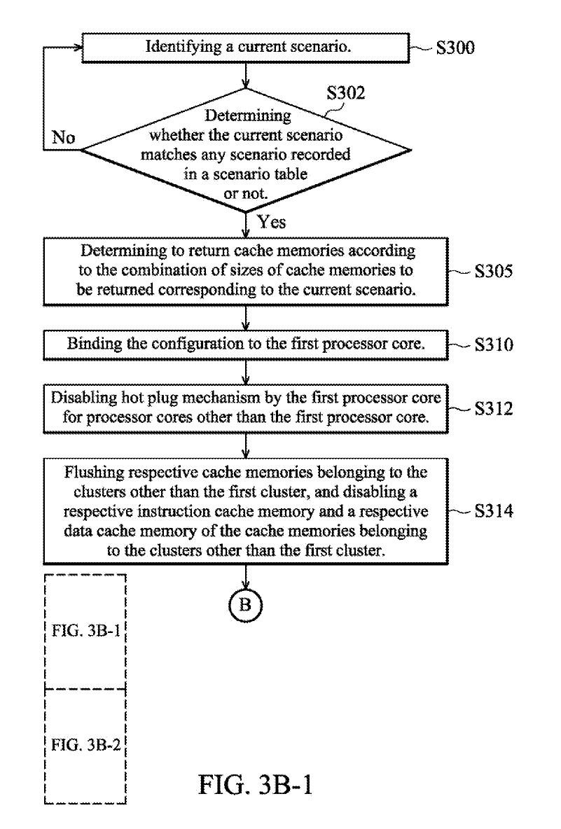

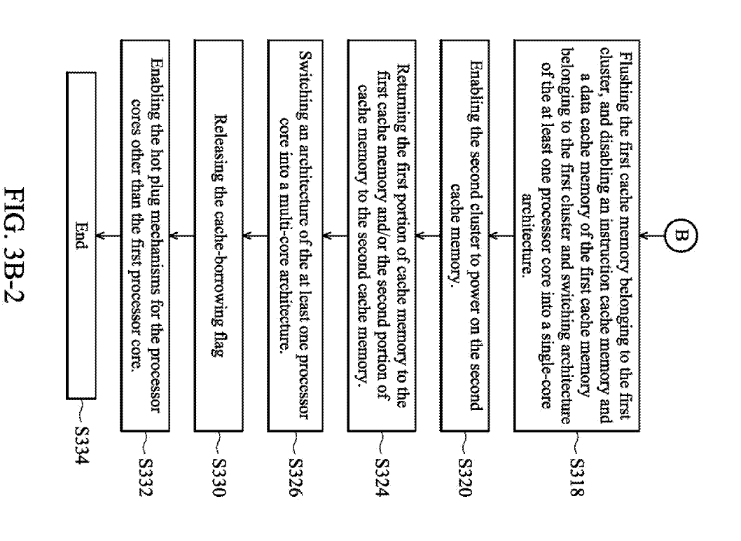

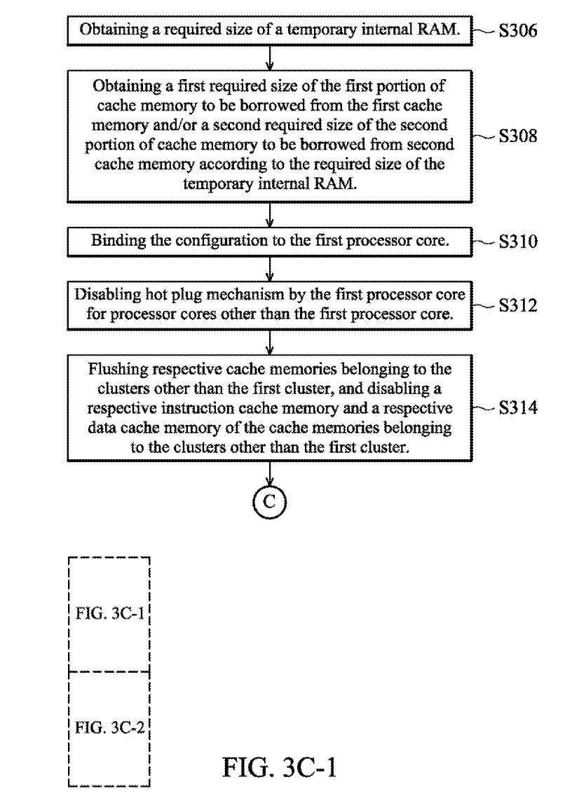

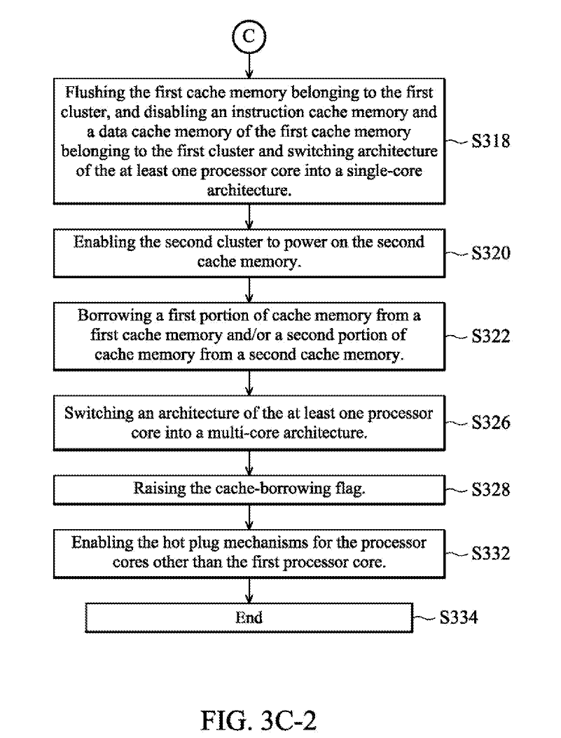

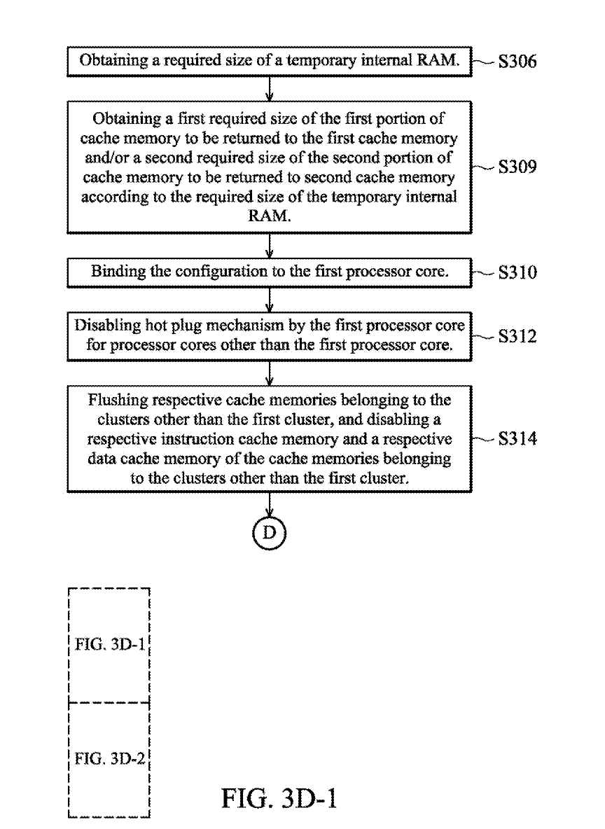

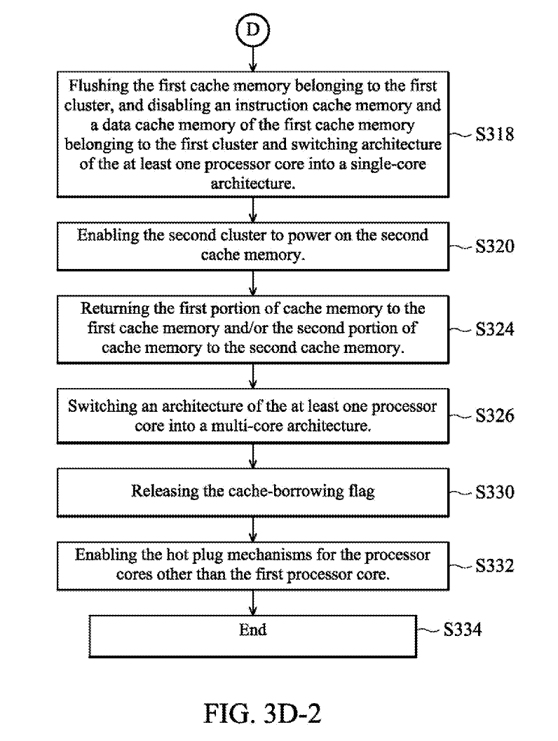

In FIG. 3A-1&3A-2 is a flow chart illustrating the borrowing of cache memories for a dynamic memory control method according to an embodiment of the invention. FIG. 3 A may be applied to the dynamic memory control systems in FIGS. 1A, 1B and 2 but not limited thereto.

In step S300, a current scenario is detected or identified. In step S302, whether the current scenario matches any predetermined scenarios which may be recorded in a scenario table or not is determined. If the current scenario does not match any scenario recorded in the scenario table, step S300 is executed again. If the current scenario matches at least one scenario recorded in the scenario table, the flow goes to step S304 for determining to borrow cache memories according to the combination of sizes of cache memories to be borrowed corresponding to the current scenario. Afterwards, in step S310, the configuration is bound to the first processor core which means that the first processor core will execute the operation of borrowing at least one cache memory. It is noted that the first processor core may be CPU0 or a specific processor core for handling interrupt requests in some embodiments but is noted limited thereto. In step S312, the hot plug mechanism is disabled for processor cores other than the first processor core. The hot plug mechanism may be disable by the first processor core but is limited thereto.

In addition, step S314 is executed for flushing respective cache memories belonging to the clusters other than the first cluster, and disabling a respective instruction cache memory and a respective data cache memory of the cache memories belonging to the clusters other than the first cluster. The following step S318 is executed for flushing the first cache memory belonging to the first cluster, and disabling an instruction cache memory and a data cache memory of the first cache memory belonging to the first cluster and switching an architecture of the at least one processor core into an single-core architecture. Afterwards, in step S320, the second cluster is enabled to power on the second cache memory. In step S322, a first portion of cache memory is borrowed from a first cache memory and/or a second portion of cache memory is borrowed from a second cache memory. Step S326 is then executed for switching architecture of the at least one processor core into a multi-core architecture. Afterwards, in step S328, the cache-borrowing flag is raised. Since the cache-borrowing is raised, the clusters other than the first cluster cannot be required to be powered off. Step S332 is executed for enabling the hot plug mechanisms for the processor cores other than the first processor core, and the process ends in step S334.

FIG. 3B-1&3B-2 is a flow chart illustrating the returning of cache memories for a dynamic memory control method according to an embodiment of the invention. FIG. 3 A may be applied to the dynamic memory control systems in FIGS. 1A, 1B and 2 but not limited thereto.

It should be noted that in the returning process, steps S300 and S302 are the same as the borrowing process and would not be repeated again. After step S302, step S305 is executed for determining to return cache memories according to the combination of sizes of cache memories to be returned corresponding to the current scenario. Afterwards, step S310 to S320 are executed as illustrated in the process flow of FIG. 3A-1&3A-2 and would not be explained again. After step S320, step S324 is executed for returning the first portion of cache memory to the first cache memory and/or the second portion of cache memory to the second cache memory. Step S326 is then executed for switching an architecture of the at least one processor core into a multi-core architecture. Afterwards, in step S330, the cache-borrowing flag is released. Since the cache-borrowing flag is released, the power of the second cluster could be automatically powered off by other power-saving mechanisms for decreasing the power consumption if the loading is not heavy. In other words, the power of the second cluster could be automatically powered off rather than powered off by users. Step S332 is executed for enabling the hot plug mechanisms for the processor cores other than the first processor core, and the process ends in step S334.

FIG. 3C-1&3C-2 is a flow chart illustrating the borrowing of cache memories for a dynamic memory control method according to another embodiment of the invention. FIG. 3 C may be applied to the dynamic memory control systems in FIGS. 1A, 1B and 2 but not limited thereto. FIG. 3 C may be applied to the dynamic memory control systems in FIGS. 1A, 1B and 2 but not limited thereto. FIG. 3C-1&3C-2 is similar to FIG. 3A-1&3A-2, different mainly replacing steps S300-S304 in FIG. 3A-1&3A-2 with steps S306-S308.

Specifically, the process flow may start with step S306 of obtaining a required size of a temporary internal RAM. The required size of the temporary internal RAM could be configured by the share controller or the driver layer or the first processor core. Afterwards, step S308 is executed for obtaining a first required size of the first portion of cache memory to be borrowed from the first cache memory and/or a second required size of the second portion of cache memory to be borrowed from second cache memory according to the required size of the temporary internal RAM. The following steps S310-S334 can be analogized from embodiment of FIG. 3A-1&3A-2, thus omitted here for brevity.

FIG. 3D-1&3D-2 is a flow chart illustrating the returning of cache memories for a dynamic memory control method according to another embodiment of the invention. FIG. 3 C may be applied to the dynamic memory control systems in FIGS. 1A, 1B and 2 but not limited thereto. FIG. 3D-1&3D-2 is similar to FIG. 3B-1&3B-2, different mainly replacing steps S300-S305 in FIG. 3B-1&3B-2 with steps S306-S309.

Specifically, the process flow starts with step S306 of obtaining a required size of a temporary internal RAM. Afterwards, step S309 is executed for obtaining a first required size of the first portion of cache memory to be returned to the first cache memory and/or a second required size of the second portion of cache memory to be returned to the second cache memory according to the required size of the temporary internal RAM. The following steps S310-S334 can be analogized from embodiment of FIG. 3B-1&3B-2, thus omitted here for brevity.

In an embodiment, a dynamic memory control system is disclosed. The dynamic memory control system can include a plurality of clusters, each comprising at least one processor core respectively and at least one cache memory. In other words, each processor core belongs to a corresponding cluster. Similarly, each cache memory belongs to a corresponding cluster. In some operation occasions, referred to as a first mode for example, each of the cache memories is exclusively used by a corresponding cluster of the plurality of cluster without being accessed any processor core belonging to the corresponding cluster. In contrast, in some other operation occasions, referred to as a second mode for example, the exclusive usage of the cache memories by corresponding clusters becomes a shared usage.

In some embodiments, in the second mode, at least a first portion of a first cache memory can be exclusively used by a first cluster of the plurality of cluster without being accessed any processor core not belonging to the first cluster. Moreover, the first portion of the first cache memory can utilized as a temporary internal RAM (random access memory) to be accessed by not only the at least one processor core belonging to the first cluster but also at least one processor core not belonging to the first cluster and/or one or more software/hardware modules other than the clusters, for example, an image processor core such as an encoder or decoder. Furthermore, portions of more than two cache memories can also be utilized as a single contiguous temporary internal RAM.

In the embodiments, a dynamic memory control method is disclosed for borrowing and returning cache memories in a run time. Because the temporary internal RAM is composed of the borrowed cache memories, it could be dynamically returned, for example, when the bandwidth is efficient and/or the loading of the processor cores is not heavy. Compared with the conventional method of arranging the permanent internal memory, the dynamic memory control method of the embodiments may reduce more cost and improve efficiency.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

Various functional components or blocks have been described herein. As will be appreciated by persons skilled in the art, the functional blocks will preferably be implemented through circuits (either dedicated circuits, or general purpose circuits, which operate under the control of one or more processors and coded instructions), which will typically comprise transistors that are configured in such a way as to control the operation of the circuitry in accordance with the functions and operations described herein. As will be further appreciated, the specific structure or interconnections of the transistors will typically be determined by a compiler, such as a register transfer language (RTL) compiler. RTL compilers operate upon scripts that closely resemble assembly language code, to compile the script into a form that is used for the layout or fabrication of the ultimate circuitry. Indeed, RTL is well known for its role and use in the facilitation of the design process of electronic and digital systems.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

1. A dynamic memory control method for a plurality of clusters each comprising at least one processor core respectively and for a plurality of cache memories each belonging to a corresponding cluster of the clusters, comprising:
borrowing a first portion of cache memory from a first cache memory of the plurality of cache memories and/or a second portion of cache memory from a second cache memory of the plurality of cache memories to allow the first portion of cache memory and/or the second portion of cache memory to be utilized as a temporary internal RAM (random access memory), wherein the first cache memory belongs to a first cluster of the plurality of clusters, and the second cache memory belongs to a second cluster of the plurality of clusters; and
returning the first portion of cache memory to the first cache memory and/or the second portion of cache memory to the second cache memory such that each of the first portion of cache memory and/or the second portion of cache memory is exclusively used by the at least one processor core of the first cluster and/or the at least one processor core of the second cluster.

2. The dynamic memory control method as claimed in claim 1, wherein when the first portion of cache memory and/or the second portion of cache memory are utilized as the temporary internal RAM, the temporary internal RAM is shared by the at least one processor core of the first cluster and/or the at least one processor core of the second cluster with either or both of the at least one processor core of the plurality of clusters and one or more other modules other than the at least one processor core of the first cluster and/or the at least one processor core of the second cluster.

3. The dynamic memory control method as claimed in claim 1, wherein in step of utilizing the first portion of cache memory and/or the second portion of cache memory as the temporary internal RAM, a boot loader is executed in the temporary internal RAM to initiate an external RAM.

4. The dynamic memory control method as claimed in claim 1, further comprising translating a memory access request for the temporary internal RAM into a first memory access request for the first portion of cache memory and/or a second memory access request for the second portion of cache memory.

5. The dynamic memory control method as claimed in claim 1, wherein when the first portion of cache memory and the second portion of cache memory are both borrowed, they are utilized as a single contiguous temporary internal RAM.

6. (canceled)

7. The dynamic memory control method as claimed in claim 1, wherein the borrowing step and the returning step are performed by a first processor core of the first cluster.

8. The dynamic memory control method as claimed in claim 7, further comprising disabling a hot plug mechanism for processor cores other than the first processor core.

9. The dynamic memory control method as claimed in claim 8, further comprising after the step of disabling the hot plug mechanism for processor cores other than the first processor core, flushing respective cache memories belonging to the clusters other than the first cluster, and disabling a respective instruction cache memory and a respective data cache memory of the cache memories belonging to the clusters other than the first cluster.

10. The dynamic memory control method as claimed in claim 9, further comprising after the flushing step and disabling step, flushing the first cache memory belonging to the first cluster, disabling an instruction cache memory and a data cache memory of the first cache memory belonging to the first cluster and switching an architecture of the at least one processor core into a single-core architecture.

11. The dynamic memory control method as claimed in claim 10, further comprising after the flushing step and the disabling step for the first cache memory and the switching step for the first processor core, enabling the second cluster to power on the second cache memory.

12. The dynamic memory control method as claimed in claim 7, further comprising after either the borrowing step or the returning step, switching an architecture of the at least one processor core into a multi-core architecture.

13. (canceled)

14. The dynamic memory control method as claimed in claim 1, further comprising:
identifying a current scenario;
determining whether the current scenario matches any scenario recorded in a scenario table or not, wherein the scenario table records a plurality of scenarios each corresponding to different combinations of sizes of cache memories to be borrowed; and
when the current scenario matches a scenario recorded in the scenario table, determining to borrow cache memories according to the combination of sizes of cache memories to be borrowed corresponding to the current scenario.

15. The dynamic memory control method as claimed in claim 1, further comprising:
obtaining a required size of the temporary internal RAM; and
obtaining a first required size of the first portion of cache memory to be borrowed from the first cache memory and/or a second required size of the second portion of cache memory to be borrowed from the second cache memory according to the required size of the temporary internal RAM.

16. A dynamic memory control system for a plurality of clusters each comprising at least one processor core respectively and for a plurality of cache memories each belonging to a corresponding cluster of the clusters, comprising:
a first cache memory of the plurality of cache memories, wherein the first cache memory belongs to a first cluster of the plurality of clusters; and
a second cache memory of the plurality of cache memories which is different from the first cache memory, wherein the second cache memory belongs to a second cluster of the plurality of clusters which is different from the first cluster, wherein
when a first portion of cache memory is borrowed from the first cache memory of the plurality of cache memories and/or a second portion of cache memory is borrowed from a second cache memory of the plurality of cache memories, the first portion of cache memory and/or the second portion of cache memory is utilized as a temporary internal RAM (random access memory), and
when the first portion of cache memory is returned to the first cache memory and/or the second portion of cache memory is returned to the second cache memory, each of the first portion of cache memory and/or the second portion of cache memory is exclusively used by the at least one processor core of the first cluster and/or the at least one processor core of the second cluster.

17. The dynamic memory control system as claimed in claim 16, wherein when the first portion of cache memory and/or the second portion of cache memory are utilized as the temporary internal RAM, the temporary internal RAM is shared by the at least one processor core of the first cluster and/or the at least one processor core of the second cluster with the at least one processor core of the plurality of clusters which is other than the at least one processor core of the first cluster and/or the at least one processor core of the second cluster.

18. The dynamic memory control system as claimed in claim 16, wherein when the first portion of cache memory and/or the second portion of cache memory are utilized as the temporary internal RAM, a boot loader is executed in the temporary internal RAM to initiate an external RAM.

19. The dynamic memory control system as claimed in claim 16, wherein a memory access request for the temporary internal RAM is translated into a first memory access request for the first portion of cache memory and/or translated into a second memory access request for the second portion of cache memory.

20. The dynamic memory control system as claimed in claim 16, wherein when the first portion of cache memory and the second portion of cache memory are both borrowed, they are utilized as a single contiguous temporary internal RAM.

21. (canceled)

22. The dynamic memory control system as claimed in claim 16, wherein the borrowing and the returning of the first portion and/or the second portion of cache memories are performed by a first processor core of the first cluster.

23. The dynamic memory control system as claimed in claim 22, wherein a hot plug mechanism is disabled for processor cores other than the first processor core.

24. The dynamic memory control system as claimed in claim 23, wherein after the hot plug mechanism is disabled for processor cores other than the first processor core, respective cache memories belonging to the clusters other than the first cluster are flushed, and a respective instruction cache memory and a respective data cache memory of the cache memories belonging to the clusters other than the first cluster are disabled.

25. The dynamic memory control system as claimed in claim 24, wherein after flushing the respective cache memories and disabling the respective instruction cache memory and the respective data cache memory, the first cache memory belonging to the first cluster is flushed, an instruction cache memory and a data cache memory of the first cache memory belonging to the first cluster are disabled, and architecture of the at least one processor core is switched into a single-core architecture.

26. The dynamic memory control system as claimed in claim 25, wherein after flushing the first cache memory, disabling the instruction cache memory and the data cache memory and switching the first processor core, the second cluster is enabled to power on the second cache memory.

27. The dynamic memory control system as claimed in claim 22, wherein after either the borrowing and the returning of the first portion and/or the second portion of cache memories, an architecture of the at least one processor core is switched into a multi-core architecture.

28. (canceled)

29. The dynamic memory control system as claimed in claim 16, further comprising:
a scenario table recording a plurality of scenarios each corresponding to different combinations of sizes of cache memories to be borrowed; and
a current scenario to be identified, wherein whether or not the current scenario matches any scenario recorded in the scenario table is determined, and when the current scenario matches a scenario recorded in the scenario table, the borrowing of cache memories is determined according to the combination of sizes of cache memories to be borrowed corresponding to the current scenario.

30. The dynamic memory control system as claimed in claim 16, wherein a required size of the temporary internal RAM is obtained, and a first required size of the first portion of cache memory to be borrowed from the first cache memory and/or a second required size of the second portion of cache memory to be borrowed from second cache memory are obtained according to the required size of the temporary internal RAM.

31-33. (canceled)
